(19) United States
(12) Patent Application Publication
(10) Pub. No.: US 2002/0047440 A1
(43) Pub. Date: Apr. 25, 2002

(54) ROTATING ELECTRICAL MACHINE COMPRISING HIGH-VOLTAGE STATOR WINDING AND SPRING-DEVICE SUPPORTING THE WINDING AND METHOD FOR MANUFACTURING SUCH MACHINE

(76) Inventors: MATS LEIJON, VASTERAS (SE); BENGT KOTHMAN, VASTERAS (SE); HANS-OLOF KALLDIN, VASTERAS (SE); BERTIL LARSSON, VASTERAS (SE)

Correspondence Address: OBLON SPIVAK MCCLELLAND, MAIER & NEUSTADT, 1755 JEFFERSON DAVIS HIGHWAY, FOURTH FLOOR, ARLINGTON, VA, 22202

(21) Appl. No.: 09/147,318

(22) PCT Filed: May 27, 1997
(86) PCT No.: PCT/SE97/00906

(30) Foreign Application Priority Data
May 29, 1996 (SE) 9602079-7
Nov. 4, 1997 (SE) 9604030-8

(51) Int. Cl. H02K 1/00; H02K 3/00

(52) U.S. Cl. 310/179

(57) ABSTRACT

A rotating electric machine with high-voltage stator winding and spring-device supporting the winding and method for manufacturing the same is employed for high-voltage applications. In particular, the machine includes a stator with a winding that is made of a high-voltage cable that is drawn through a slot in the stator of the rotating electric machine. A spring member biases the high-voltage cable against a wall of the stator so as to avoid damaging an outer surface of the cable during operation of the machine. The outer surface of the cable is susceptible to being damaged because an outer surface of the cable includes a semiconducting material that could possibly be damaged if subject to vibration or abrasion against a slot wall of the slot.

The present invention relates in a first aspect to a rotating electric machine of the type described in the preamble to claim 1, e.g. synchronous machines, normal asynchronous machines as well as dual-fed machines, applications in asynchronous static current converter cascades, outerpole machines and synchronous flow machines.

A second aspect of the invention relates to a method of the type described in the preamble to claim 13.

The machine is intended primarily as a generator in a power station for generating electric power. The machine is intended to be used at high voltages. High voltages shall be understood here to mean electric voltages in excess of 10 kV. A typical operating range for the machine according to the invention may be 36 to 800 kV.

Similar machines have conventionally been designed for voltages in the range 6-30 kV, and 30 kV has normally been considered to be an upper limit. This generally means that a generator must be connected to the power network via a transformer which steps up the voltage to the level of the power network, i.e. in the range of approximately 100-400 kV.

By using high-voltage insulated electric conductors, in the following termed cables, with solid insulation similar to that used in cables for transmitting electric power in the stator winding (e.g. XPLE cables) the voltage of the machine may be increased to such levels that it may be connected directly to the power network without an intermediate transformer. XPLE=Cross-linked polyethylene.

This concept generally implies that the slots in which the cables are placed in the stator be deeper than conventional technology requires (thicker insulation due to higher voltage and more turns in the winding). This entails new problems with regard to cooling, vibrations and natural frequencies in the region of the coil end, teeth and winding.

Securing the cable in the slot is also a problem the cable must be inserted into the slot without its outer layer being damaged. The cable is subjected to currents having a frequency of 100 Hz which cause a tendency to vibration and, besides manufacturing tolerances with regard to the outer diameter, its dimensions will also vary according to variations in temperature (i.e. load variations).

Although the predominant technology when supplying current to a high-voltage network for transmission, sub-transmission and distribution, involves inserting a transformer between the generator and the power network as mentioned in the introduction, it is already known that attempts are being made to eliminate the transformer by generating the voltage directly at the level of the network. Such a generator is described in U.S. Pat. Nos. 4,429,244, 4,164,672 and 3,743,867.

The manufacture of coils for rotating machines is considered possible with good results up to a voltage range of 10-20 kV.

Attempts at developing a generator for voltages higher than this have been in progress for some time, as is evident from “Electrical World”, Oct. 15, 1932, pages 524-525, for instance. This describes how a generator designed by Parson 1929 was constructed for 33 kV. A generator in Langerbrugge, Belgium, is also described which produced a voltage of 36 kV. Although the article also speculates on the possibility of increasing the voltage levels, development of the concepts upon which these generators were based ceased. This was primarily due to deficiencies in the insulating system where several layers of varnish-impregnated mica foil and paper were used.

Certain attempts at lateral thinking in the design of synchronous generators are described in an article entitled “Water-and-oil-cooled Turbogenerator TVM-300” in J. Elektrotechnika, No. 1 1970, pages 6-8 of U.S. Pat. No. 4,429,244 “Stator of generator” and in Russian patent specification CCCP Patent 955369.

The water-and-oil-cooled synchronous machine described in J. Elektrotechnika is intended for voltages up to 20 kV. The article describes a new insulation system consisting of oil/paper insulation which enabled the stator to be completely immersed in oil. The oil can then be used as coolant at the same time as constituting insulation. A dielectric oil-separating ring is provided at the internal surface of the core to prevent oil in the stator from leaking out towards the rotor. The stator winding is manufactured from conductors having oval, hollow shape, provided with oil and paper insulation. The coil sides with the insulation are retained in the slots with rectangular cross-section by means of wedges. Oil is used as coolant both in the hollow conductors and in cavities in the stator walls. However, such cooling systems necessitate a large number of connections for both oil and electricity at the coil ends. The thick insulation also results in increased radius of curvature of the conductors which in turn causes increased size of the coil overhang.

The above-mentioned US patent relates to the stator part of a synchronous machine comprising a magnetic core of laminated plate with trapezoid slots for the stator winding. The slots are stepped since the need for insulation of the stator winding is less in towards the rotor where the part of the winding located closest to the neutral point is situated. The stator part also includes dielectric oil-separating cylinders nearest the inner surface of the core. This part will increase the excitation requirement in comparison with a machine lacking this ring. The stator winding is manufactured from oil-saturated cables having the same diameter for each layer of the coil. The layers are separated from each other by means of spacers in the slots and secured with wedges. Characteristic of the winding is that it consists of two “half-windings” connected in series. One of the two half-windings is situated centrally inside an insulating sheath. The conductors of the stator winding are cooled by surrounding oil. A drawback with so much oil in the system is the risk of leakage and the extensive cleaning-up process required in the event of a fault condition. The parts of the insulating sheath located outside the slots have a cylindrical part and a conical screening electrode whose task it is to control the electrical field strength in the area where the cable leaves the plate.

It is evident from CCCP 955369 that in another attempt at increasing the rated voltage of a synchronous machine, the oil-cooled stator winding consists of a conductor with insulation for medium-high voltage, having the same dimension for all layers. The conductor is placed in stator slots in the shape of circular, radially situated openings corresponding to the cross-sectional area of the conductor and place required for fixation and cooling. The various radially located layers of the winding are surrounded and fixed in insulating tubes. Insulating spacer elements fix the tubes in the stator slot. In view of the oil cooling an inner dielectric ring is also required here to seal the oil coolant from the inner air gap. The construction illustrated has no stepping of the insulation or of the stator slots. The construction shows an extremely narrow, radial waist between the various stator slots, entailing a large slot leakage flow which greatly affects the excitation requirement of the machine.

In a report from the Electric Power Research Institute, EPRI, EL-3391, from April 1984 an exposition is given of the generator concept in which a higher voltage is achieved in an electric generator with the object of connecting such a generator to a power network without intermediate transformers. The report deems such a solution to offer satisfactory gains in efficiency and financial advantages. The main reason that in 1984 it was considered possible to start developing generators for direct connection to the power network was that by that time a superconducting rotor had been developed. The considerable excitation capacity of the superconducting field makes it possible to use air-gap windings with sufficient thickness to withstand the electric stresses.

By combining the construction of an excitation circuit, the most promising concept of the project, together with winding, a so-called “monolith cylinder armature”, a concept in which two cylinders of conductors are enclosed in three cylinders of insulation and the whole structure is attached to an iron core without teeth, it was deemed that a rotating electric machine for high voltage could be directly connected to a power network. This solution implied that the main insulation had to be made sufficiently thick to withstand network-to-network and network-to-earth potentials. Besides it requiring a superconducting rotor, an obvious drawback with the proposed solution is that it requires a very thick insulation, thus increasing the size of the machine. The coil ends must be insulated and cooled with oil or freones in order to direct the large electric fields in the ends. The whole machine is to be hermetically enclosed to prevent the liquid dielectric medium from absorbing moisture from the atmosphere.

The present invention is related to the above-mentioned problems associated with avoiding damage to the surface of the cable upon insertion into the stator slots and avoiding wear against the surface caused by vibration during operation. The slot through which the cable is inserted is relatively uneven or rough since in practice it is extremely difficult to control the position of the laminated plates sufficiently exactly to obtain a perfectly uniform surface. The rough surface has sharp edges which may shave off parts of the semiconductor layer surrounding the cable. This leads to corona and break-through at operating voltage.

When the cable is placed in the slot and adequately clamped there is no risk of damage during operation. Adequate clamping implies that forces exerted (primarily radially acting current forces with double mains frequency) do not cause vibrations that cause wear on the semiconductor surface. The outer semiconductor is to thus be protected against mechanical damage even during operation.

During operation the cable is also subjected to thermal loading so that the XLPE material expands. The diameter of a 145 kV XLPE cable, for instance, increases by about 1.5 mm at an increase in temperature from 20 to 70° C. Space must therefore be allowed for this thermal expansion.

Against this background the object of the present invention is to solve the problems of achieving a machine of the type under consideration so that the cable is not subjected to mechanical damage during operation as a result of vibrations, and which permits thermal expansion of the cable. Achieving this would enable the use of cables that do not have a mechanically protecting outer layer. In such case the outer layer of the cable consists of a thin semiconductor material which is sensitive to mechanical damage.

According to the invention this has been solved by giving a machine of the type described in the preamble to claim 1 the special features defined in the characterizing part of this claim.

In the present application the terms “radial”, “tangential” and “axial” direction have the stator as reference unless expressly stated otherwise. The terms “deactivated” and “activated” spring member are also used in the application. By “deactivated spring member” is here implied a spring member that is locked in a certain position so that its spring force is absorbed by the locking member but is otherwise substantially eliminated. By “activated spring member” is implied a spring member that is not locked in this manner and is thus free to exert a spring force.

Deactivating the spring members as defined in claim 1 when they are arranged in the slots, either before they are inserted into the slots or after they have been inserted, enables them to be restrained so that they do not impede or complicate insertion of the cable into the slots since a clearance is hereby obtained. Once the cable is in place and the spring members are activated they will be able to abut against the cable lead-throughs to support them, hereby eliminating the risk of the damages mentioned above caused by vibration. The free clearance during winding of the cables also reduces the risk of damage when winding is being performed. During operation the cable lead-through have room to expand.

In a preferred embodiment of the method a support body which can be pressed against at least one cable lead through, preferably two cable lead-throughs, is arranged between the spring member and the cable lead-throughs, in which case the spring member is arranged at one of the slot walls. In a modification of this embodiment, spring members and support bodies are arranged at both slot walls. The arrangement of such support bodies in this manner enables the cable to be effectively secured with forces operating in radial and tangential direction and the support members can be shaped with support surfaces to fit the cable penetrations in order to achieve optimum distribution of pressure.

In a preferred alternative of this embodiment, a pressure member is arranged to press one or both support members out towards the relevant slot wall. The necessary free space is hereby created in a simple manner for the cable lead-trhough.

In a particularly preferred embodiment the pressure member serves to deactivate the spring members by compressing them. The spring members can then easily be activated by simply removing the pressure member once the cable is in place.

It is advantageous to arrange the spring members in the form of a corrugated, preferably laminated plate spring, a “Krempel wave”.

This embodiment enables a practical way of deactivating or activating the spring member by gluing the plate spring to a flat surface so that it is flat and then activating it by releasing the adhesive joint, e.g. by heating. Such an embodiment may in certain cases be an advantageous alternative to using the pressure member mentioned earlier for deactivating and activating the spring member, and in other cases may constitute a complement thereto.

The embodiment of a glued Krempel wave may also be used to advantage for the radial clamping of the windings, and in that case arranged on a lid fitted to cover the opening of the slot and act in activated state against the radially innermost cable lead-theough.

The above and other advantageous embodiments of the method according to the invention are defined in the sub-claims to claim 1.

By using corrugated plate springs to clamp the cable lead-throughs as in the machine according to the invention, a simple and expedient arrangement is achieved to eliminate the problems encountered when high-voltage cable is used in the windings, as discussed in the introduction. The machine according to the invention also has the advantage of being suitably manufactured in accordance with the method of the invention.

Advantageous embodiments of the machine according to the invention are defined in the sub-claims to claim 13. The special advantages as revealed in the account above of various embodiments of the method according to the invention are achieved in these embodiments.

The invention will be explained in more detail in the following description of preferred embodiments, with reference to the accompanying drawings in which;

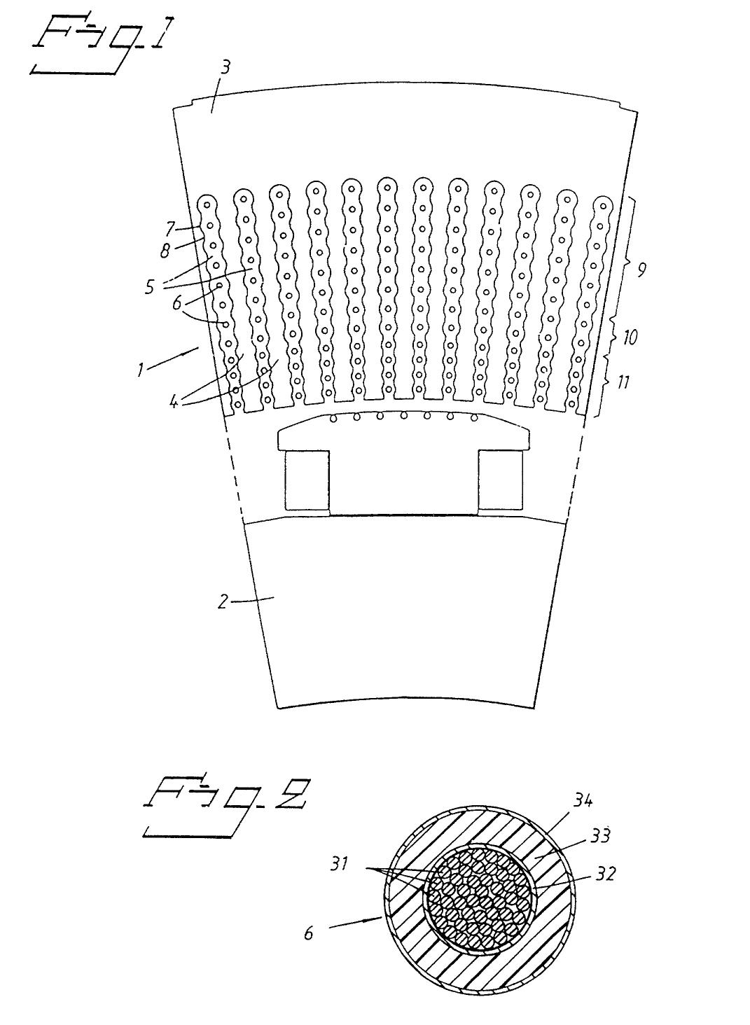

FIG. 1 shows schematically an end view of a sector of the stator in a machine according to the invention,

FIG. 2 shows a cross-section through a cable used in the machine according to the invention,

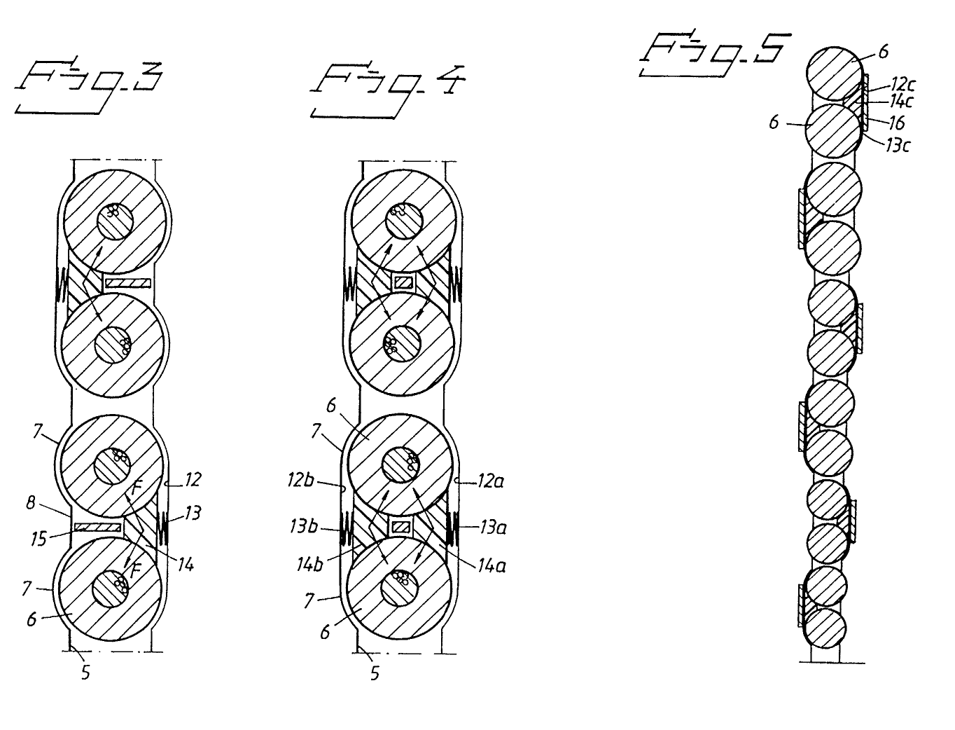

FIG. 3 shows a partial section through a stator slot according to a first embodiment of the invention,

FIG. 4 shows a section corresponding to that in FIG. 3, but illustrating a second embodiment of the invention,

FIG. 5 shows a section through a stator slot according to a third embodiment of the invention,

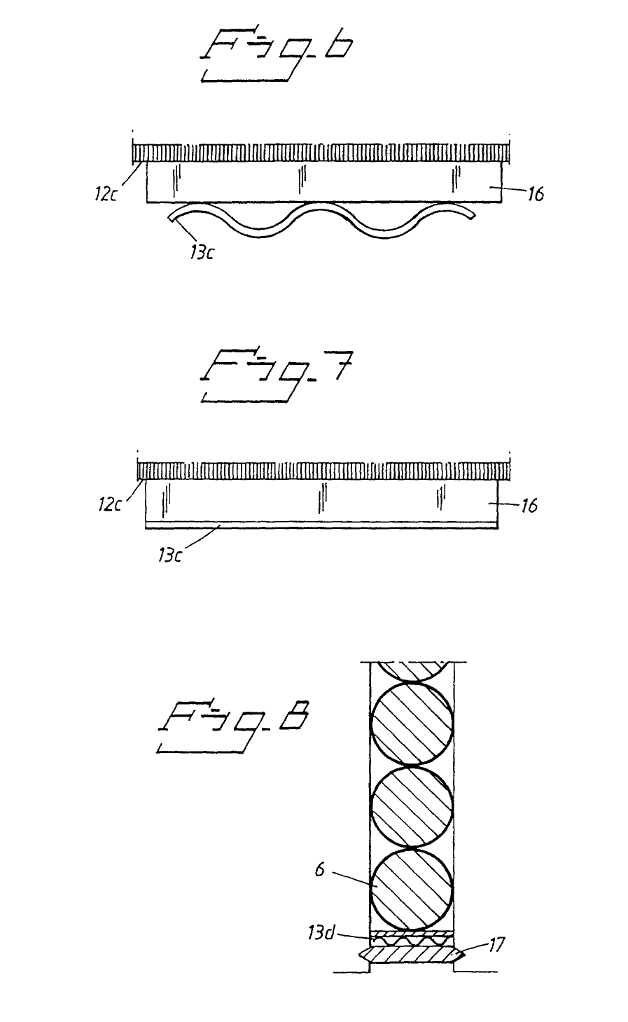

FIG. 6 shows an activated spring member according to a preferred embodiment of the invention,

FIG. 7 shows the spring member in FIG. 6 deactivated,

FIG. 8 is a section through a stator slot according to a fourth embodiment of the invention.

In the axial view shown schematically in FIG. 1 through a sector of the stator 1 of the machine, its rotor is designated 2. The stator is composed in conventional manner of a laminated core of sheet steel. The figure shows a sector of the machine, corresponding to one pole division. From a yoke part 3 of the core situated radially outermost, a number of teeth 4 extend radially in towards the rotor 2 and are separated by slots 5 in which the stator winding is arranged. The cables 6 in the windings are high-voltage cables which may be of substantially the same type as high-voltage cables used for power distribution, so-called XLPE cables. One difference is that the outer mechanically protective sheath that normally surrounds such a cable has been eliminated. The cable thus comprises only the conductor, an inner semi-conductor layer, an insulating layer and an outer semi-conducting layer. The semi-conductor layer, sensitive to mechanical damage, is thus exposed on the surface of the cable.

In the drawings the cables 6 are illustrated schematically, only the conducting central part of the cable lead-through or coil side being illustrated. As can be seen, each slot 5 has varying cross-section with alternating wide parts 7 and narrow parts 8. The wide parts 7 are substantially circular and surround cable lead-throughs, whereas the waist parts between these form narrow parts 8. The waist parts serve to radially position each cable lead-throught. The cross-section of the slot as a whole also becomes slightly narrower in radial direction inwards. This is because the voltage in the cable lead-throughs is lower the closer they are situated to the radially inner part of the stator. Slimmer cable lead-throughs can therefore be used here, whereas increasingly coarser cable lead-throughs are required further out. In the example illustrated cables of three different dimensions are used, arranged in three correspondingly dimensioned sections 9.19, 11 of the slots 5.

FIG. 2 shows a cross-sectional view of a high-voltage cable 6 according to the present invention. The high-voltage cable 6 comprises a number of strand parts 31 made of copper (Cu), for instance, and having circular cross-section. These strand parts 31 are arranged in the middle of the high-voltage cable 6. Around the strand parts 31 is a first semi-conducting layer 32. Around the first semi-conducting layer 32 is an insulating layer 33, e.g. XLPE insulation. Around the insulating layer 33 is a second semi-conducting layer 34. The concept “high-voltage cable” in the present application thus need not include the metal screen and the outer protective sheath that normally surround such a cable for power distribution.

In the embodiment illustrated in FIG. 3 the slot 5 has a profile that deviates somewhat from that shown in FIG. 1 in that alternate waist parts 8 have greater width. On the one side of alternate waist parts 8 the slot wall has a profile section 12 that follows the tangent between adjacent wide, circular parts 7. The waist parts thus enlarged are arranged alternately where the slot wall profile section 12 formed as a tangent is alternately situated on both slot walls. The purpose of the enlarged parts is to provide room for spring and support member. It will be understood that the enlarged part need not necessarily be formed by the wall section 12 following a tangent. The section 12 may be either outside or inside this tangent plane and need not be situated per se in a radial plane to the stator, or even be flat. Furthermore, the enlarged portions need not be arranged alternately. Instead all of them may be arranged on the same side of the slot.

In the space with substantially triangular cross-section that is formed between the wall section 12 and the two cable parts 6 is a cable support body 14, and between this and the wall section 12 is a spring member 13. The cable support body 14 extends axially through the whole slot, thereby forming a rod-like element. The spring member 13, suitably made of a corrugated laminated plate spring containing glassfibre, extends axially through the whole slot. The spring member 13 may also be arranged at only certain points in axial direction, as may also the support body 14.

The support body 14 has a support surface in the shape of a cylinder arc facing each cable lead-through 6, its radius fitting the radius of the cable so that a large support surface is obtained. The support body 14 is pressed against the cable lead-throughs by means of the spring member 13 with a force F directed radially relative to the cable lead-troughs 6 so that each cable lead-throughs 6 is clamped between the support body 14 and the opposite wall, along the whole length of the cable lead-through in the example shown.

To enable insertion of the cable during winding it must be ensured that the support body 14 is not in the way. FIG. 3 shows a way of achieving this when the support bodies 14 and spring members 13 are placed in the slots 6 before the cable is wound. A pressure member 15 is inserted between each support body 14 and the wall portion opposite. This may be in the form of a rod extending along the whole slot. The rod has a width in the transverse direction of the slot that is adjusted so that the rod 15 presses the support member 14 against the wall section 12 and against the action of the spring member 13. This is thus locked in a deactivated position and the support body 14 is pressed back by the rod 15.

When the cable has been wound the rods 15 are withdrawn from the slot. Locking of the spring member is thus released so that it is activated and presses the support body 14 against the cable lead-throughs 6.

FIG. 4 illustrates an embodiment based on the same principle as that illustrated in FIG. 3, but somewhat modified. Briefly this can be described as a double-acting variant. In this embodiment the opposite slot wall is also formed as a wall section connecting the circular parts 7 so that no waist part is formed. Space is hereby provided for a support body 14a, 14b with spring members 13a, 13 to be arranged on each side of the slot. The pressure member or rod 15a is in this case arranged between the two support bodies 14a, 14b and presses these against respective wall parts 14a, 14b against the action of respective spring members 13a, 13b. In other respects the design is in principle the same as that described in connection with FIG. 3 and the measures for deactivating and activating the spring members are equivalent.

FIG. 5 illustrates another embodiment which differs from that illustrated in FIG. 3 primarily in the method of deactivation and activating the spring member 13c. The spring member 13c is manufactured in the form of a corrugated laminated plate spring which, with the slot wall 12c as support, presses the support body 14c, preferably made of rubber, against the cable lead-throughs 6. A plate 16 is also arranged between the plate spring 13c and the slot wall 12c.

FIGS. 6 and 7 show the spring member 13c of FIG. 5 on an enlarged scale in activated and deactivated state, respectively.

The plate spring 13c, which may consist of triazine resin and glass fabric or polyimide resin and glass fabric, for instance, is in FIG. 7 glued to one side of the plate 16, the other side of which abuts the slot wall 12c. The plate 16 may suitably consist of glass fabric/bakelite. The plate spring 13c is thus formed to assume a flat shape and then deactivated. The type of glue is selected so that it melts at the temperature, about 70° C., reached in this area when the machine is in operation. When the glue melts, the plate spring 13c loosens from its forced flat shape and assumes the corrugated shape shown in FIG. 6. It has thus been activated for its spring function and presses against the support body 14c in FIG. 5.

The plate 16 with the plate spring 13c glued onto it is inserted axially into its place in the slot before the cable is drawn. Since the plate spring 13c is deactivated, the support body 14c is restrained so that it does not impede insertion of the cable.

FIG. 8 shows yet another embodiment of the invention. The Figure shows the radially inner end of a slot, whose radially inwardly facing opening is covered by a slot lid 17. A plate spring 13d is arranged on the slot lid 17 in similar manner to that described in connection with FIGS. 6 and 7. The slot lid 17 with plate spring 13d may be applied after the cables 6 have been wound. The plate spring 13d is then activated either as described or by means of a few light knocks on the outside of the slot lid 17, thereby causing the glue joint to be released. When the plate spring 13d has been activated it will press radially upwards against the inner cable lead-through and, via that, also against the cable lead-throughs situated further out.

1. A method of manufacturing the stator for a rotating electric machine, characterized in that a high-voltage cable is drawn through slots in the stator to form the stator windings, the cable having an insulation system comprising at least outer and inner semiconducting layers and solid insulation, and in that spring members are deactivated and arranged in at least one slot, and that said spring members are activated after the cables have been wound.

2. A method as claimed in claim 1, in which a first spring member is arranged to be supported by one of the slot walls, that a first support body is arranged between the spring member and at least one cable lead-through, preferably two cable lead-throughs, said first support body being arranged to be able to be pressed against at least one cable lead-through.

3. A method as claimed in claim 2, wherein a second spring member is arranged to be supported by the opposite slot wall and immediately opposite said first spring member, that a second support body is arranged between said second spring member and said at least one cable lead-through, said second support body being arranged to be able to be pressed against said at least one cable lead-through.

4. A method as claimed in claim 2, wherein a pressure member is arranged between said first support body and the opposite slot wall so that the pressure member, via said first support body, presses against said first spring member.

5. A method as claimed in claim 3, wherein a pressure member is arranged between said first and second support bodies so that the pressure member, via these, presses against said first and second spring members.

6. A method as claimed in claim 4 or claim 5, wherein said pressure members are arranged so that said spring members are deactivated and that the spring members are activated by removal of the pressure member.

7. A method as claimed in any of claims 1-6, wherein the spring member comprises a corrugated, preferably laminated, plate spring.

8. A method as claimed in claim 7, wherein said deactivation entails gluing the plate spring to a flat surface so that it acquires a flat shape and that said activation entails releasing the glue joint.

9. A method as claimed in claim 8, dependent on claim 1, wherein the plate spring is glued to the inside of a slot lid fitted at the radially inwardly directed opening of the slot.

10. A method as claimed in claim 8 or claim 9, wherein the glue joint is released by heating, preferably by the transfer of heat generated in the cable.

11. A method as claimed in claim 9, wherein the glue joint is released by knocking against the outside of the lid.

12. A method as claimed in any of claims 1-11, wherein said spring members extend along substantially the entire axial extension of the stator.

13. A rotating electric machine comprising a stator with windings (6) drawn through slots (5) in the stator (1), characterized in that at least one winding (6) is a high-voltage cable with an insulation system comprising at least two semiconducting layers (32, 34), each layer essentially constituting an equipotential surface, and also including solid insulation (33), and in that at least one spring member in the form of a corrugated, preferably laminated plate spring (13c, 13d) is arranged to exert pressure on at least one cable lead-through.

14. A machine as claimed in claim 13, wherein at least one of said layers (32, 34) has substantially the same coefficient of thermal expansion as the solid insulation (33).

15. A rotating electric machine as claimed in claim 13 or claim 14, wherein said spring member (13c) is arranged between one slot wall (12c) and a support member (14c) which is held pressed by the spring member (13c) against at least one, preferably two cable lead-throughs (6).

16. A rotating electric machine as claimed in claim 13 or claim 14, wherein said spring member (13d) is arranged between a slot lid (17) fitted on an inwardly directed opening of the slot and the radially innermost cable lead-through (6).

17. A rotating electric machine as claimed in any of claims 14-16, wherein said spring members (13c, 13d) extend along substantially the whole axial extension of the stator (1).
